(19) United States
(12) Patent Application Publication
(10) Pub. No.: US 2016/0003294 A1
(43) Pub. Date: Jan. 7, 2016

(54) DEVICE FOR GUIDING THE MOVEMENT OF A SLIDING ELEMENT AND KITCHEN FURNISHING

(71) Applicant: Grass GmbH, Hoechst (AT)

(72) Inventor: Gerlinde LINDINGER, Wals (AT)

(21) Appl. No.: 14/748,406

(22) Filed: Jun. 24, 2015

(30) Foreign Application Priority Data
Jul. 7, 2014 (DE) 20 2014 103 102.2

(51) Int. Cl. F16C 29/00; F16C 29/04

(52) U.S. Cl. CPC F16C 29/005; F16C 29/04; F16C 29/004

(57) ABSTRACT

A device for guiding the movement of a sliding element which can be arranged on a side wall portion by means of the device, wherein the device includes a carrier rail and a pull-out rail which is displaceable relative to the carrier rail, and wherein the carrier rail comprises a longitudinal leg which extends in the longitudinal extension of the device. According to the invention, the device includes connecting means for installing the device on a profile arrangement of the side wall portion, wherein the connecting means include bearing means for mounting on the profile arrangement by means of engaging behind, and the bearing means are present on an outside surface of the longitudinal leg which points to the side wall portion in the mounted state.

This application claims the benefit under 35 USC §119(a)-(d) of German Application No. 20 2014 103 102.2 filed Jul. 7, 2014, the entirety of which is incorporated herein by reference.

### FIELD OF THE INVENTION

The invention relates to a device for guiding the movement of a sliding element and kitchen furnishings.

### BACKGROUND OF THE INVENTION

Devices for guiding a sliding element, which is received so as to be movable on side wall portions, are known in the furniture sector as in the case of kitchen furniture items and kitchen furnishings, for example, in the case of ovens. The sliding element is, for example, a food carrier or baking grill or baking tray of an oven, a pull-out floor or a drawer.

As a rule, the movable guiding of the sliding element is effected by way of two guide units on two sides of the sliding element at a common height on oppositely located vertical side walls of the furniture item or of the kitchen furnishing item. The respective guide unit acts between the sliding element and the associated side wall.

The guide units are realized as telescopic single extension or partial extension or full extension runners. In the case of partial extension runners, a guide unit consists of a carrier rail and a guide rail, the guide rail being assigned to the sliding element and being movable with the sliding element and the carrier rail being fixable on the wall portion. In the case of a full extension runner, a center rail is additionally present between the carrier rail and the guide rail so as to be displaceable.

In the furniture sector, guide units of the aforementioned type on the one hand have to meet complicated requirements or rather have to be realized in a mechanically stable, compact and reliable manner.

### SUMMARY OF THE INVENTION

It is the object of the present invention to provide devices designated in the introduction or corresponding kitchen furnishing items in a manner that is technically and economically advantageous, in particular, with regard to a space-saving arrangement and an advantageous installation, for example in the case of ovens.

The invention proceeds from a device for guiding the movement of a sliding element, in particular, from an oven pull-out device for guiding the movement of a food carrier of an oven, wherein the sliding element can be arranged on a side wall portion by means of the device, and wherein the device includes a carrier rail which is assignable to the side wall portion and a pull-put rail which is connectable to the sliding element and is displaceable relative to the carrier rail, and wherein the carrier rail composes a longitudinal leg which extends in the longitudinal direction of the device. The device according to the present invention can be realized as a single extension or partial extension runner or as a full extension runner with a center rail between the carrier rail and the pull-out rail.

The core of the present invention consists in that the device comprises connecting means for installing the device on a profile arrangement of the side wall portion, wherein the connecting means include bearing means for mounting on the profile arrangement by means of engaging behind, and the bearing means are present on an outside surface of the longitudinal leg which points to the side wall portion in the mounted state. The mounted state is the mounted state of the device on the side wall portion or on the profile arrangement. The engaging behind with the bearing means relates in particular to a movement for installing the device during assembly, by way of which the device is introduced perpendicularly to the side wall portion or to the profile arrangement. The engaging-behind interaction of the bearing means on the profile arrangement takes place along the last part of the introduction path, a certain force having to be applied in order to push in portions on the bearing means and/or the profile arrangement or to deform them elastically in the short term. In the mounted state, the elastic deforming is fully or substantially reset again.

The bearing means and the profile arrangement are matched to one another such that in the mounted state of the device bearing forces are active for the permanent stable bearing arrangement of the device on the side wall portion.

With the device connected on the side wall by way of the undercut, the weight of the device, with the sliding element installable thereon, is received and a bearing arrangement of the sliding element, which is in particular on both sides, with in each case a device according to the invention on both sides of the sliding element is realized, one device each acting between a side of the sliding element and in each case one of two oppositely situated side wall portions.

The profile arrangement can be associated with the side wall, or can be provided thereon as a separate part, for example subsequently. According to the first case, for example, the profile arrangement is realized on the relevant part of the side wall in a fixed or integral manner thereon, in particular, protruding with respect to a flat inside surface of the side wall portion. In an advantageous manner, the profile arrangement is present as a separate unit, for example, in the case of ovens as side panels or side wall panels which can be fitted releasably on respective oppositely situated side wall portions with in each case several profile elements extending horizontally one above another. This is realized, in particular, in the case of ovens in order to accommodate several baking trays vertically spaced apart one above another in the oven cabinet.

In particular in the case of ovens, standard or commercially available side panels, which provide the profile arrangement, are present inside on both side walls.

Even in the case of ovens where, using the side panels, pulling out and manually supporting a front edge of the food carrier is possible, which is awkward and involves the user risking burning himself, the device according to the invention is usable in an advantageous manner. Using the present invention, it is possible to guide the food carrier in a supported manner over the entire pull-out path of the sliding element.

The device according to the present invention can be used efficiently, for example, to retrofit ovens which only comprise statically acting side panels. Consequently, pull-out sliding guides can be installed in a simple and sturdy manner as partial extension or full extension runners for, for example, baking trays or food carriers.

The profile arrangement is realized, for example, protruding with respect to a flat surface of the side wall portion, in particular, with narrow profiles which are oppositely situated in a vertically spaced manner and extend in particular in a parallel manner lengthwise in the depth of the side wall portion. The profile portions of the profile arrangement can be, for example, rod-shaped or rail-shaped. The profile arrangement is formed, in particular, as a rod or grid structure, as is the case with commercially available side panels in a useful volume of an oven.

As an alternative to this, the profile arrangement can be provided in a non-protruding manner on the side wall portion, for example, with webs or grooves which are realized in or on the side wall.

The profile arrangement comprises, as a rule, profile regions which are oppositely situated in a vertically spaced manner, between which the bearing means are installable so as to engage behind.

In a preferred manner, the bearing means of the device are integrally molded on a portion which is aligned vertically in the state of use, such as a longitudinal leg of the carrier rail, or are fixed thereon in a captive manner. In particular, the bearing means are not screwing devices or push-in studs which can be screwed or pushed into holes in the side wall. The carrier rail is developed, in particular, as a simply or multiply bent sheet metal part, in the simple case as a folded sheet with right-angled bends such as, for example, a profile rail which is L-shaped or U-shaped in cross section.

In an advantageous manner, in the longitudinal direction of the device the connecting means comprise bearing elements which are spaced apart from one another and are insertable between oppositely situated profile portions of the profile arrangement in order to install the device on the profile arrangement. The bearing elements, which are associated with the bearing means and are, in particular, identical among themselves, serve for realizing a detachable connection between the device and the side wall portion. With the spacing between the at least two bearing elements, in particular, with a spacing approximately according to the length of the carrier rail by way of which part of a depth of the side wall portion is bridgeable, a multiple point bearing arrangement or a mechanically stable bearing arrangement of the device on the side wall portion is achieved. The installing of the device in a material-free region between in particular vertically spaced, oppositely situated profile portions is consequently advantageously possible.

Over and above this, it is advantageous that the connecting means include at least two bearing elements, in particular precisely two bearing rollers. With two bearing elements, the connection and bearing arrangement of the device can be realized in a manner that saves material and is mechanically sufficiently fixed. Bearing rollers are usable in an advantageous manner as clamping or rolling elements.

It is also advantageous, when viewed in the longitudinal direction of the carrier rail, a bearing element is positioned in a front and/or in a rear end region of the longitudinal leg. In particular, at least two identical bearing elements are present, of which one bearing element is positioned in a front end region of the longitudinal leg and one bearing element is positioned in a rear region of the longitudinal leg, in particular at the same height on the longitudinal leg.

It is also advantageous that, when viewed in the longitudinal direction of the carrier rail, a bearing element is positioned in a middle region of the longitudinal leg. This enables movement of the carrier rail relative to the profile arrangement to be set up, for example.

In addition, according to an advantageous modification of the present invention, it is proposed that the connecting means include a bearing element which is received so as to be rotatable on the longitudinal leg. In particular, precisely two rotatably mounted bearing rollers are present. The bearing rollers are developed in an identical manner in particular. With the rotatability of the bearing rollers, a rolling motion of the bearing rollers and consequently a relative movement of the carrier rail with respect to the side wall portion is realizable in an advantageously selective manner or if desired. In the case of a standard pull-out runner without a center rail, an extension width or an extension section of the sliding element can also be increased relative to the side walls compared to a standard pull-out runner with a carrier rail that is fixed to the side wall, by the section which the carrier rail is able to extend by means of the rotatable bearing rollers with respect to the side wall. When the carrier rail is extended together with the pull-out rail present thereon, the bearing rollers roll along a bottom profile portion of the profile arrangement, whereas a small amount of play of the bearing rollers remains with respect to an upper profile portion of the profile arrangement, which is located vertically opposite the bottom profile portion. In spite of this, a holding function of the bearing rollers can be set up with an engagement behind or an undercut on the upper profile portion as the play of the bearing rollers with respect to the upper profile portion is very small or, where applicable, is only within a fraction of a millimeter.

In addition, it is advantageous that the connecting means include two profile elements which are spaced apart and are developed so as to match the bearing elements, the bearing elements being insertable between the profile elements. The profile elements are in particular round or angular rod elements. The profile elements can be in particular component parts of commercially available side panels of ovens.

A further advantageous development of the object according to the present invention is characterized in that the connecting means comprise two profile elements which are spaced apart and are coordinated for a releasable arrangement on the profile arrangement. In particular, the elements comprises profile elements which extend parallel next to one another. The profile elements can be developed, in particular, as one component which is additionally installable on a commercially available side panel of ovens. The profile elements are in particular coordinated for suitable use on a commercially available side panel of the oven. The profile elements can consequently also be utilized in an advantageous manner for retrofitting ovens with commercially available side panels. Consequently, an arrangement of the side wall portion is supplemented in a suitable manner for the bearing means or the device to be mounted by engaging behind on the side wall portion with the side panel.

It is also advantageous that a spacing between two profile elements and a height dimension of the bearing elements are matched to one another. With the vertical height dimension which is effective in the installed state, the bearing elements can be fastened in a holding manner when installed by engaging behind with the profile elements at a vertical spacing. The height dimension is, for example, a diameter dimension of the disk-shaped or roller-like bearing elements.

In addition, it is advantageous that the bearing elements and the two profile elements which are spaced apart are matched in such a manner that the bearing elements are movable in a sliding and/or rolling manner in the longitudinal extension of the profile elements relative to the profile elements. The direction of the longitudinal extension of the profile elements corresponds to the direction of extension or retraction of the horizontal movement path of the sliding element which is provided with the device. Consequently, the carrier rail can be moved out relative to the fixed side wall portion and moved back into a free interior region of the furniture item or of the oven, whereby the maximum possible degree of extension can be increased. Consequently, the sliding element in the fully extended state is accessible on all sides for a user unobstructed by adjacent regions of the furniture item or of the oven. In an advantageous manner, for example, a hot baking dish can be lifted from or replaced on a food carrier that has been moved out of the oven, whereas otherwise, with food carriers that can only be extended partially out of the interior of the oven, the risk of the user burning himself by contact with the hot food carrier or walls of the oven cabinet is increased.

In an advantageous manner, the connecting means comprise two profile elements which are spaced apart and provide a run-in region for inserting the bearing elements, which are installed on the carrier rail, in a simplified manner at the end face between the profile elements. This makes it possible to mount the device in a simplified manner.

In an advantageous manner, the connecting means comprise a stop arrangement for a mechanical stop of a bearing element on one of the profile elements. In particular, a stop is provided hereby at a defined position for a movement in the longitudinal direction of the profile elements when the carrier rail reaches a maximum extension position in the direction of movement of the sliding element.

The invention additionally relates to a kitchen furnishing with a useful volume which is delimited by oppositely situated side wall portions, having a device according to one of the abovementioned realizations.

For example, the kitchen furnishing can be an oven or a refrigerator.

In particular, the side wall portions are oppositely situated vertical sides of a hollow and heatable useful volume of an oven.

Consequently, the discussed advantages can be realized in the case of the corresponding kitchen furnishing.

### BRIEF DESCRIPTION OF THE DRAWINGS

Further features and advantages of the invention are explained in more detail by way of a schematically represented movement guidance device according to the invention.

FIG. 1 shows a perspective view of a schematic representation of a movement guidance device according to the invention which is installed on a profile arrangement;

FIG. 2 shows the arrangement according to FIG. 1 from the side;

FIG. 3 shows a rear perspective representation of an end portion of the arrangement according to FIGS. 1 and 2; and

FIG. 4 shows a front view of the rear end of the arrangement shown in FIG. 3.

### DETAILED DESCRIPTION OF THE INVENTION

The figures show a movement guidance device 1 according to the invention arranged on a profile arrangement, the profile arrangement being installable in a releasable but fixed manner on a first side wall (not shown) of an oven having a useful volume of an associated baking oven.

The movement guidance device 1 serves for guiding, in a movable, horizontal manner, the movement of a food carrier (not shown) with a horizontal supporting plane for the food to be cooked or for the food to be heated, it being possible for the food carrier to be developed, for example, as a flat supporting tub, baking tray or as a supporting grille. The food carrier can be moved into and out of the oven part of the associated baking oven by means of two movement guidance devices according to the present invention which are situated opposite one another at a height. With the food carrier fully retracted and the front door of the oven closed, the food to be cooked can be heated on the food carrier.

For guiding the sliding movement in the slide-out direction P1 and in the slide-in direction P2, a further movement guidance device 1 (not shown) according to the present invention is active on the food carrier. The further movement guidance device is received by means of a corresponding profile arrangement on a further or second side wall which is located opposite and parallel to the first side wall.

The movement guidance device 1 includes a carrier rail 2 which is assignable to a side wall portion of the first side wall and a pull-out rail 3 which, by means of bearing means (not shown in detail), is movable in a telescopic manner on the carrier rail 2 or is connected to the carrier rail so as to be displaceable. The pull-out rail 3 serves for releasably connecting the food carrier which can be placed, for example, on the pull-out rail 3 and is displaceable together with the food carrier in the direction P1 or P2.

The figures show the pull-out rail 3, depending on how the mechanical stops are present, partially or fully retracted in the direction P2 relative to the state of the carrier rail 2 fixed on the side wall portion, a front part piece of the pull-out rail 3 projecting beyond the front end of the carrier rail 2 and the rear ends of the two rails 2, 3 only being offset a little with respect to one another in the longitudinal direction.

The carrier rail 2, which is formed from a multiply bent metal sheet, is U-shaped in cross section and includes a higher outer vertical leg 14, an inner vertical leg 16 and a bottom 15 which is aligned horizontally and is present between them. The pull-out rail 3 engages the leg 16.

Bearing elements, which are associated with connecting means and are realized as a front roller 4 and as a rear roller 5, are present on the carrier rail 2. The rollers 4, 5 are present at a common height on an outside surface 14a of the leg 14 protruding in a front end portion and a rear end portion in the longitudinal direction of the carrier rail 2. The rollers 4, 5 are developed in an identical manner and comprise a concavely formed, circumferentially extending circumferential path 4a or 5a. The rollers 4, 5 can be mounted in a fixed or rotatable manner on the leg 14.

For arranging the movement guidance device 1 on the side wall portion, the profile arrangement includes a framework-like grid arrangement 6 which is releasably fixable on the inside of the associated side wall portion, for example with push-in portions of the profile arrangement which are insertable and fixable, for example latchable, in suitably prepared indentations or openings in the side wall portion.

The grid arrangement 6 includes interconnected straight or oblique rods or rods that have been bent at the end in part, for example produced from metal polygonal or round material. The grid arrangement 6 accordingly comprises a front vertical rod 7 and a rear vertical rod 8 which are spaced horizontally approximately corresponding to the length of the carrier rail 2. A bottom longitudinal rod 9, a central longitudinal rod 10 and a top longitudinal rod 11, which are in each case bracket-shaped or U-shaped, extend horizontally between the vertical rods 7, 8, fixedly fixed thereon. The longitudinal rods 9 to 11 consequently comprise, in each case at the end, short end portions which are bent around at right angles, by means of which the longitudinal rods 9 to 11 are connected, for example welded, in each case on the front rod 7 and on the rear rod 8. The identical longitudinal rods 9 and 10, with their central parts which extend parallel to the length of the carrier rail 2, are spaced somewhat further horizontally from the vertical rods 7, 8 than the top longitudinal rod 11. As a result, the top longitudinal rod 11 is at a sufficient spacing from the food carrier (not shown), which can be installed on the above pull-out rail 3.

In addition, for the fixed bearing arrangement or receiving means of the rollers 4, 5 and consequently of the movement guidance device 1, a bearing element receiving means, which is realized as a bracket-shaped roller receiving means 17, is present on the grid arrangement 6 with a top rod portion 12 and a bottom rod portion 13. The roller receiving means 17 is either present in a fixedly fixed manner or is installed fitted thereon or latched therein in a fixed but releasable manner, which also makes it possible for the roller receiving means 17 to be retrofitted on the longitudinal rods 10 and 11 or for the roller receiving means 17 to be removed.

The rod portions 12 and 13 are produced continuously or integrally from bent round material, in particular corresponding to the material development of the longitudinal rods 10, 11. The rod portions 12 and 13 are aligned in a straight line and parallel with respect to one another and with respect to the central parts of the longitudinal rods 10, 11 over the substantial length or between the longitudinal rods 10, 11.

In a material-free space between the parallel part lengths of the rod portions 12 and 13, the two rollers 4, 5 are received or held certainly so as to be releasably installable but fixedly mounted. To mount the movement guidance device 1 in a simplified manner, the movement guidance device 1 or the two rollers are installed in a preferred manner on the grid arrangement 6 with the roller receiving means 17 when the grid arrangement 6 is removed from the side wall. The grid arrangement 6 with the movement guidance device 1 fixed thereon is then fixedly installed or plugged-in on the side wall portion, as shown in the figures.

So as to be installed in particular in a clamping manner between the rod portions 12 and 13, the rollers 4, 5 are developed in size and form in a manner that matches the rod portions 12 and 13 or the vertical spacing between the rod portions. In particular, the form of the circumferential paths 4a and 5a, which are in particular identical, is matched to the outside form of the rod portions 12 and 13.

As an alternative to this, the rollers 4, 5 or other bearing elements can also be mounted between the longitudinal rods 9 and 10 so as to engage behind them. To this end, when using rollers, the roller diameter or the diameter of the circumferential paths 4a, 5a must be suitably coordinated with the vertical spacing between the longitudinal rods 9, 10. Consequently, the roller receiving means 17 can be dispensed with, stops being necessary, where appropriate, at the front and at the back of the longitudinal rods 9, 10.

In the exemplary embodiment shown, the circumferential paths 4a and 5a are adapted with their concave form to the radius of the cylindrical rod portions 12 and 13. In the mounted state of the movement guidance device 1 shown in the figures, the rollers 4, 5, are held with the circumferential paths 4a, 5a in each case in a clamping manner between the rod portions 12, 13.

The roller receiving means 17 is provided at the front with a semi-circular bend, by means of which the horizontal central portions of the longitudinal rods 12 and 13 are interconnected. The front roller 4 is held in a clamped manner between the longitudinal rods 12 and 13 so as to adhere to the bend and is additionally secured against a movement of the carrier rail 2 in the direction P1, which is advantageous when the food carrier is pulled out in the direction P1.

The roller receiving means 17 comprises at the rear end a push-in aid 18, according to which the rod portions 12, 13 are realized in each case widening obliquely or together at their rear end. The top rod portion 12 comprises a rear portion 12a which is angled upward with respect to the horizontal central part of the rod portion 12 and the bottom rod portion 13 comprises a rear portion 13a which is angled downward with respect to the horizontal central part of the rod portion 13. The angulation is in particular similar in each case and is, for example, approximately 20 angular degrees in each case to the horizontal. Consequently, the movement guidance device 1 or the rollers 4 and 5 can be threaded between the widened regions of the push-in aid 18 in the rear region with the roller 4 in front and then pushed in between the straight central portions of the rod portions 12, 13 in a clamping manner in the direction P1.

As an alternative to this, the rollers 4, 5 can be fastened in a clamped-in manner, where applicable, by introducing the movement guidance device 1 from the side or with the rollers 4, 5 at the front between the two rod portions 12 and 13, for example by the movement guidance device 1 being aligned with the leg 14 in a somewhat tilted manner or being moved obliquely with respect to the alignment shown in the figures relative to the grid arrangement 6 such that the rollers 4, 5 can be clipped-in between the rod portions 12 and 13. To this end, the movement guidance device 1 is moved out of the oblique alignment into the upright alignment shown in the figures.

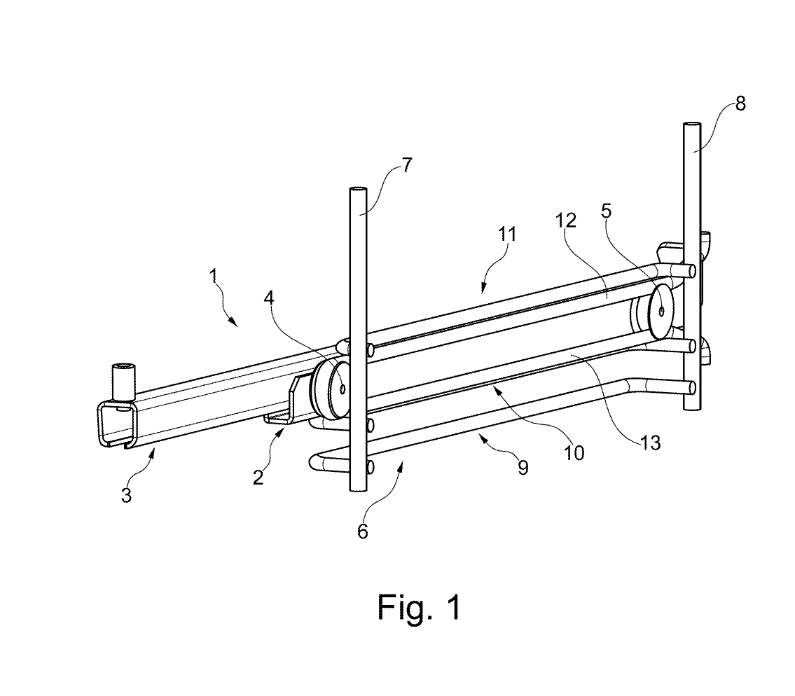

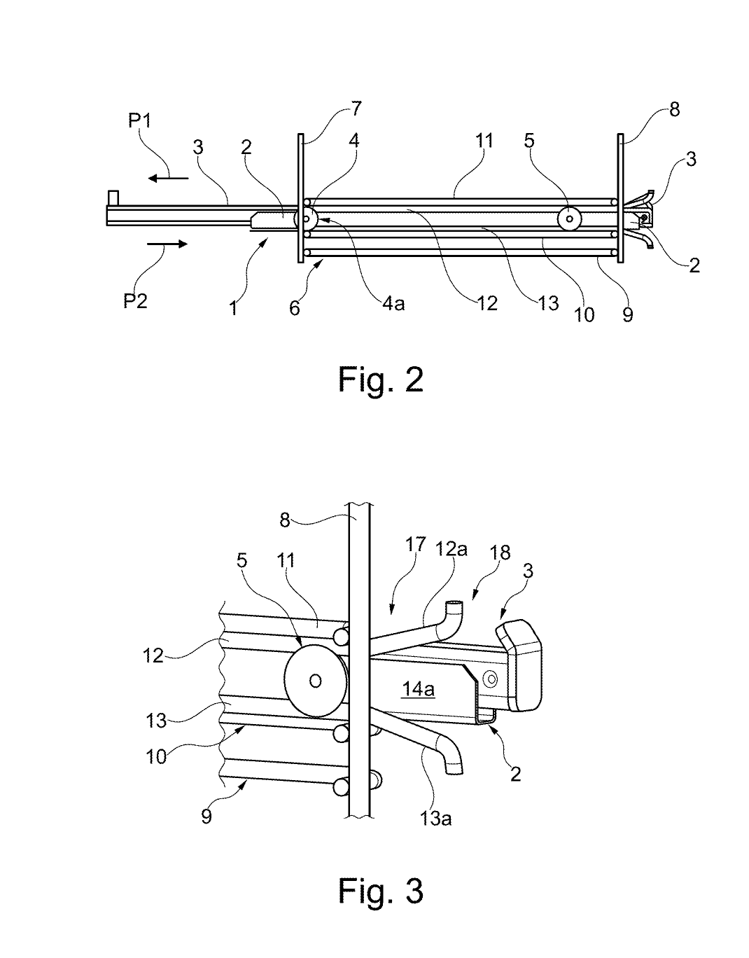

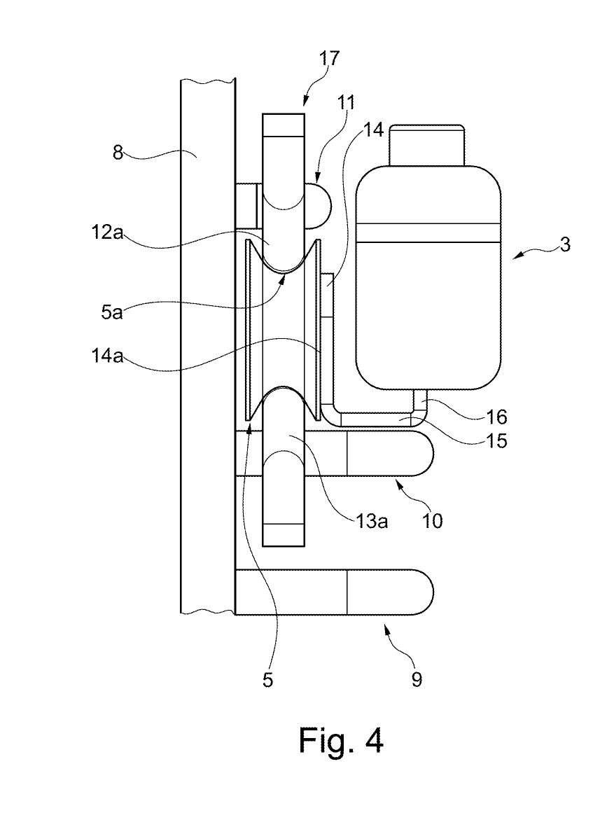

Instead of the rollers 4 and 5, other bearing elements which basically function in a similar manner to the rollers 4, 5 can also be used. Different rollers or differently dimensioned rollers can be used which are matched in such a manner to the rod portions 12 and 13 or to the vertical spacing between them, for example, with a diameter of a path base of the circumferential path which is somewhat smaller than the vertical spacing between the rod portions 12 and 13. Consequently, the rollers resting on the bottom of the rod portion 13 can be displaceable in a rolling manner on the bottom rod portion 13. If the further roller with respect to the rear roller is not offset forward but backward, positioned approximately in the center of the overall length of the carrier rail 2, a corresponding extension path in the direction P1 and back in the direction P2 is realizable with the carrier rail 2, whereby the pull-out rail 3 and consequently the food carrier, compared to the arrangement according to FIGS. 1 to 4 with the positionally-fixed carrier rail, is able to be pulled further out of the oven, which is operator-friendly. The carrier rail 2 is pulled out to its maximum until the central roller strikes against the front bend of the rod portions 12, 13. Where applicable, a mechanical stop must be additionally provided at the back for delimiting the push-in movement of the carrier rail 2 relative to the roller receiving means 17 or to the default of a maximum push-in path.

In principle, different sizes and/or forms of bearing elements or rollers 4, 5 can be chosen for the respective existing vertical spacing between the rod portions 12, 13 on the movement guidance device 1.

### LIST OF REFERENCES

1 Movement guidance device
2 Carrier rail
3 Pull-out rail
4 Roller
4a Circumferential path
5 Roller
5a Circumferential path
6 Grid arrangement
7 Front vertical rod
8 Rear vertical rod
9 Bottom longitudinal rod
10 Central longitudinal rod
11 Top longitudinal rod
12 Top rod portion
12a Rear portion of 12
13 Bottom rod portion
13a Rear portion of 13
14 Outer vertical leg
14a Outside surface of 14
15 Bottom of 2
16 Inner vertical leg
17 Roller receiving means
18 Push-in aid

1. A device for guiding the movement of a sliding element which can be arranged on a side wall portion by means of the device comprising:
a carrier rail which is assignable to the side wall portion, a pull-out rail, which is connectable to the sliding element and is displaceable relative to the carrier rail, and connecting means for installing the device on a profile arrangement of the side wall portion,
wherein the carrier rail comprises at least a longitudinal leg which extends in a longitudinal extension direction of the device, and
wherein the connecting means include bearing means for mounting on the profile arrangement by means of engaging behind, and the bearing means are present on an outside surface of the longitudinal leg which points to the side wall portion in the mounted state.

2. The device according to claim 1, wherein in the longitudinal direction of the device the connecting means comprise bearing elements which are spaced apart from one another and are insertable between oppositely situated profile portions of the profile arrangement in order to install the device on the profile arrangement.

3. The device according to claim 1, wherein the connecting means include at least two bearing elements.

4. The device according to claim 1, wherein when viewed in a longitudinal direction of the carrier rail, a bearing element is positioned in at least one of a front end region of the longitudinal leg and a rear end region of the longitudinal leg.

5. The device according to claim 4, wherein when viewed in the longitudinal direction of the carrier rail, a bearing element is positioned in a middle region of the longitudinal leg.

6. The device according to claim 1, wherein the connecting means include a bearing element which is received so as to be rotatable on the longitudinal leg.

7. The device according to claim 1, wherein the connecting means include two profile elements which are spaced apart so as to match the bearing elements, the bearing elements being insertable between said profile elements.

8. The device according to claim 1, wherein the connecting means comprise two profile elements which are spaced apart and are coordinated for a releasable arrangement on the profile arrangement.

9. The device according to claim 7, wherein a spacing between two profile elements and a height dimension of the bearing elements are matched to one another.

10. The device according to claim 1, wherein the bearing elements and the two profile elements which are spaced apart are matched in such a manner that the bearing elements are movable in at least one of a sliding manner and a rolling manner on the profile elements relative to the profile elements.

11. The device according to claim 1, wherein the connecting means comprise two profile elements which are spaced apart and provide a run-in region for inserting the bearing elements, which are installed on the carrier rail, in a simplified manner at the end face between the profile elements.

12. The device according to claim 1, wherein the connecting means comprise a stop arrangement for a mechanical stop of a bearing element on one of the profile elements.

13. A kitchen furnishing having a useful volume which is delimited by oppositely situated side wall portions, having a device according to claim 1.

14. The device according to claim 3, wherein the at least two bearing elements are two bearing rollers.
